(19) United States
(12) Patent Application Publication
(10) Pub. No.: US 2025/0149950 A1
(43) Pub. Date: May 8, 2025

(54) MODULE, IN PARTICULAR ROTOR ASSEMBLY OR STATOR ASSEMBLY, FOR AN ELECTRICAL MACHINE, AND ELECTRICAL MACHINE

(71) Applicant: Schaeffler Technologies AG & Co. KG, Herzogenaurach (DE)

(72) Inventors: Sebastian KAISER, Starkenburg (DE); Olaf WERNER, Bühl (DE); Fabian BENESCH, Bühlertal (DE); Christoph RABER, Ottweiler-Steinbach (DE); René DAIKELER, Sasbach (DE); Shen DING, Achern (DE)

(73) Assignee: Schaeffler Technologies AG & Co. KG, Herzogenaurach (DE)

(21) Appl. No.: 18/833,464

(22) PCT Filed: Jan. 24, 2023
(86) PCT No.: PCT/DE2023/100054

§ 371 Date: Jul. 26, 2024

(30) Foreign Application Priority Data
Jan. 28, 2022 (DE) 10 2022 101 972.1

(51) Int. Cl. H02K 5/24; H02K 21/24

(52) U.S. Cl. CPC H02K 5/24; H02K 21/24

(57) ABSTRACT

A module, in particular a rotor assembly (2) or stator assembly (49), for an electrical machine (1, 45), including multiple components (3), wherein at least one volume filled with a damping fluid is formed between at least two of the components (3), wherein, for the purpose of vibration damping, the damping fluid is displaceable as a result of a change in the geometry of the volume resulting from an elastic vibration of at least one component (3) adjacent to the volume.

### CROSS-REFERENCE TO RELATED APPLICATIONS

This application is the U.S. National Phase of PCT Appln. No. PCT/DE2023/100054, filed Jan. 23, 2023, which claims priority to German Patent Application No. 10 2022 101 972.1, filed Jan. 28, 2022, the entire disclosures of which are incorporated by reference herein.

### TECHNICAL FIELD

The present disclosure relates to a module, in particular a rotor assembly or stator assembly, for an electric machine, consisting of multiple components. In addition, the present disclosure relates to an electric machine.

### BACKGROUND

Rotating electric machines, which can be operated both as generators and as electric motors, have been known for a long time. They are used to convert electrical energy into kinetic energy and/or vice versa. Such an electric machine comprises a stationary stator and a rotatably mounted rotor, each of which carries electromagnets or permanent magnets. The functional concept of an electric machine operated as an electric motor is based on the circumstance that magnetic fields generated by an electric current interact with the magnetic fields of electromagnets or permanent magnets in such a way that the rotor is set in rotation. The functional concept of an electric machine operated as a generator is based on the circumstance that a change in the magnetic field caused by the rotation of the rotor induces an electric current.

One area of application for electric machines that is becoming increasingly important is their use in motor vehicles, such as hybrid or purely electric vehicles. Here, the electric machine is part of a drive train of the motor vehicle and is used to make the electrical energy stored in an electrical energy storage system of the motor vehicle usable for the propulsion of the motor vehicle by introducing a drive torque into the drive train. In this case, the electric machine is used as an electric motor. It is also conceivable that the motor vehicle is operated in a recuperation mode, in which the electric machine acts as a generator and converts kinetic energy from the motor vehicle into electrical energy that can be used to charge the electrical energy storage system, for example.

One problem that frequently occurs with electric machines, in particular those used in motor vehicles, is unwanted vibrations or oscillations of components of the electric machine. As such, components of the electric machine, in particular the rotor assembly and/or the stator assembly, can be set into vibration due to the interaction of the magnetic fields described above as well as the dynamic processes, wherein the oscillation frequencies typically in the kHz range are usually the natural frequencies or higher modes of the components. These vibrations are not only problematic from an energy point of view, but can also often be felt and/or heard by the occupants of the vehicle. This is disadvantageous.

### SUMMARY

It is the object of the present disclosure to implement an improved concept with regard to this problem in connection with an electric machine.

According to the disclosure, the object is achieved in the module of the type mentioned at the outset in that at least one volume filled with a damping fluid is formed between at least two of the components, wherein, for the purpose of vibration damping, the damping fluid is displaceable as a result of a change in the geometry of the volume resulting from an elastic oscillation of at least one component delimiting the volume.

The disclosure is based on the finding that the oscillation energy present in the vibrating component of the electric machine is dissipated and reduced by the displacement of the damping fluid, which ultimately achieves a damping of the vibration. Due to the viscosity of the damping fluid in particular, energy is required to displace it, which is extracted from the existing oscillation and dissipated.

In the present disclosure, the component delimits the volume. This means that the volume filled with the damping fluid has multiple walls, wherein at least one of these walls is formed by the component. Due to the vibration of this component, this wall changes its position in relation to at least one of the other walls of the volume. This change in position causes the displacement or movement of the damping fluid. The damping concept implemented in the context of the present disclosure can also be referred to as squeeze oil damping.

The change in the geometry of the volume preferably takes place while the capacity of the volume remains the same, so that the approximately incompressible damping fluid only changes its geometric shape according to the change in volume. In this embodiment, the volume can be described as a closed volume. In order to ensure that the total capacity of the volume remains the same in spite of the movement of the wall, the volume can comprise a volume compensation section. This can be provided as a depression, in particular a blind bore, in at least one of the walls delimiting the volume, wherein a pressure piston which seals the depression in a fluid-tight manner and is movable towards the base is arranged at the base of the depression and is coupled to the base via a compression spring. A change in the capacity that would occur without the volume compensation section is compensated for by the movement of the pressure piston. With regard to the volume compensation section, alternative options are also conceivable, namely that a gas cushion or another compressible element is provided instead of the compression spring. Embodiments without a pressure piston are also conceivable, in which, for example, only a balance gas is provided, in particular forming a nitrogen cushion, wherein no other component such as the pressure piston is arranged between the damping fluid and the balance gas. A further conceivable option for implementing the volume compensation is by means of the principle of emulsion damping.

The volume can alternatively be an open volume. This means that the damping fluid is supplied to the volume from a damping fluid reservoir and via a damping fluid supply channel. The volume can also be open such that the damping fluid can escape from the volume into an interior space delimited by a housing of the electric machine. In this embodiment, the damping fluid further serves as a lubricant and/or coolant for the stator and rotor assembly. In this case, the damping fluid can circulate. As such, it can be conveyed from the damping fluid reservoir to the volume via the damping fluid supply channel and then conveyed further into the interior space, where it can collect in a damping fluid collecting section of the electric machine due to the influence of gravity. The damping fluid collecting section can be the damping fluid reservoir. The damping fluid can be conveyed from the damping fluid collecting section to the damping fluid reservoir. A fluid pump can be provided for conveying the damping fluid, which is, for example, arranged between the damping fluid collecting section and the damping fluid reservoir or between the damping fluid collecting section and the damping fluid supply channel.

The damping fluid can be a liquid, such as an oil, and can be pressurized. Alternatively, the damping fluid can be at ambient or atmospheric pressure.

In the module according to the disclosure, the volume can be a gap, in particular a planar gap, or comprise such a gap. In this embodiment, the vibration of the component causes a change in the width of the gap in such a way that the damping fluid arranged within the gap is displaced. With regard to the selection of the gap size, i.e., the width of the gap, it is important on the one hand that if the gap is too wide too little oscillation energy is dissipated. On the other hand, an extremely narrow gap has the effect of reducing the relative movement between the surfaces delimiting the gap. Approximately in this case, these surfaces are rigidly connected to one another, so that the energy dissipation would be insufficient for vibration damping. Overall, the gap size must therefore be selected in such a way that these two effects do not occur or at least only occur to a very small extent. Values between 0.1 mm and 0.3 mm can be considered for the gap width or gap size, for example.

The gap can be designed in a meandering or labyrinthine manner by means of interlocking projections of the components, the walls of which delimit the respective gap. This lengthens the gap due to the geometric shape of the projections, so that more damping fluid is displaced when the gap width is changed, thus increasing the damping effect.

Additionally or alternatively, in the module according to the disclosure, the volume can be or comprise a chamber. A change in the geometry of the chamber and thus a damping effect of any vibration or oscillation can be made possible by means of flexible or elastic seals that seal the chamber.

The module according to the disclosure can be a stator assembly of the electric machine. Here, the components can be a stator, in particular a disc-shaped stator, and/or a housing of the electric machine to which the stator is attached, and/or a flange attached to the housing and extending radially inwards and arranged next to the stator in the axial direction, or a housing cover arranged next to the stator in the axial direction.

The module according to the disclosure can be a rotor assembly of the electric machine. Here, a first component of the rotor assembly can be a rotor shaft and a second component of the rotor assembly can be a disc-shaped rotor of an axial flux machine, which is attached directly or indirectly to the rotor shaft, wherein the volume is formed between the rotor shaft and the rotor and/or between the rotor shaft and a third component of the rotor assembly attached to the rotor. In relation to an axis of rotation of the rotor shaft or rotor assembly, the rotor and a stator are offset and, in particular, arranged directly adjacent to one another or next to one another. The rotor can also be referred to as a rotor disc. The stator can also be disc-shaped and is attached to a rotationally fixed component of the electric machine, such as the housing.

In terms of its design, the axial flux machine can be a so-called H arrangement, wherein two rotors attached to or plugged onto the rotor shaft axially spaced apart from one another are provided, wherein the stator extends between the two rotors. As seen in a longitudinal section, the shape of the rotors together with the rotor shaft is reminiscent of an “H”. A so-called I arrangement is also conceivable, in which only one rotor is attached to the rotor shaft, wherein, as seen in the axial direction, one stator each of the electric machine is arranged on both sides of the rotor.

The oscillations and vibrations described above occur mainly at the disc-shaped rotors in axial flux machines implemented according to the H arrangement, as unbalanced axial excitation forces act on the two rotors for design-related reasons. In axial flux machines according to the I arrangement, the axial excitation forces acting on the rotor are largely compensated due to reasons of symmetry. However, with the I arrangement, such a compensation does not occur at the stators, so that corresponding vibrations on the part of the stators are to be expected. In general, i.e., in axial flux machines that are not implemented as an H or I arrangement, the oscillations or vibrations occur on components where the axial excitations do not balance each other out, in particular due to reasons of symmetry.

In practice, the fundamental mode of oscillation of the stator or rotor disc vibration, in which the radially outer region of the rotor disc oscillates back and forth along the axial direction, is particularly relevant. The geometric shape of the disc, in this case, is reminiscent of the shape of a bowl or umbrella, which is why this mode is also referred to as the umbrella mode. In addition to this fundamental mode, higher order oscillations can also be damped within the scope of the present disclosure. Examples of higher order oscillation modes that can also be damped using the concept of the present disclosure are the tilting mode and the saddle mode, wherein these designations are based on the shape of the disc that is created during oscillation in each case.

The third component can be a ring which is arranged next to the rotor as seen in the axial direction, surrounds the rotor shaft in the circumferential direction and is attached to the rotor, wherein the gap is an axial gap which extends in the axial direction and along the circumferential direction and is arranged between the ring and the rotor shaft and/or a radial gap which extends at an angle to the axial direction, in particular in the radial direction, and is arranged between the ring and a shaft shoulder which widens the rotor shaft in the radial direction and is arranged next to the ring as seen in the axial direction. In this embodiment, the oscillations occurring on the part of the rotor are transmitted to the ring, which delimits the volume and consequently transmits the force that causes the damping to the vibrating rotor.

The ring therefore delimits both the axial and radial gap. The axial gap has the geometric shape of a cylindrical shell or a hollow cylinder. The radial gap has the shape of a circular disc with a central circular recess. The axial gap and the radial gap are preferably connected to one another, in particular via an end face end of the axial gap and a radially inner end of the radial gap. As seen in the axial direction, the axial gap can be delimited or sealed by a connecting disc, which will be discussed in detail later.

The shaft shoulder can be formed in a flanged manner and/or integrally with the remaining section of the rotor shaft. Preferably, the shaft shoulder forms a circumferential projection that expands the diameter of the rotor shaft accordingly.

As seen in the radial direction, the ring can be surrounded on the outside by a sealing element, in particular a tubular and/or diaphragm-like sealing element, by means of which at least one of the gaps is sealed in a fluid-tight manner. The sealing element, which is made of an elastic plastic, for example, seals the radial gap radially outwards, for example. The tubular or hollow-cylindrical sealing element preferably surrounds the ring and the shaft shoulder completely. The sealing element can seal multiple radial gaps, wherein an elasticity of the sealing element in the radial direction enables the transfer of the damping fluid from one radial gap to another. In particular, the elasticity of the sealing element can also serve to keep the capacity of the volume constant.

The ring can be composed of multiple separate ring segments each connected to the rotor. The circular ring, as seen in the axial direction, can therefore be formed from multiple arcuate ring segments, which are in particular identical to one another. It is particularly preferred that a gap is formed between at least two of the ring segments. At least two of the ring segments can thus represent components of the rotor assembly, between which the gap, which can also be referred to as the segment gap, or the volume is formed. The segment gaps can extend in the axial and radial direction and, in particular, be arranged evenly around the axis of rotation of the rotor assembly. As seen in the radial direction towards the inside, the segment gaps can open into the axial gap and, as seen in the radial direction towards the outside, can be sealed in a fluid-tight manner by means of the sealing element and/or connected to one another. Furthermore, the segment gaps, as seen in the axial direction, can open into the radial gap and, as seen in the axial direction in the opposite direction, can be delimited or sealed by means of the aforementioned connecting disc.

In a particularly preferred embodiment of the module according to the disclosure and designed as a rotor assembly, the rotor has spring tongues extending at least partially in the radial direction in an inner region as seen in the radial direction and connected to the ring such that rotor movements caused by a natural oscillation of the rotor can be transmitted to the ring via the spring tongues. The spring tongues can be separated from one another via slots. The spring tongues can each be connected to one of the ring segments, for example by means of a screw. As already explained above, oscillations occur in the disc-shaped rotor primarily in the umbrella mode, so that the resulting oscillatory movements or amplitudes are mainly present in the radially outer region of the rotor. The spring tongues transmit or guide the oscillations or the movements occurring as part of the oscillations into the radially inner region of the rotor. As such, the vibrational movement of the rotor in its radially outer region that occurs as part of the umbrella mode causes the spring tongue arranged in the same circular segment of the rotor to move in the opposite direction, so that a similar movement coupling is realized as with a slotted disc spring. The spring tongues cause a transmission of the oscillatory movement of the rotor from the radially outer region to the radially inner region of the rotor and thus to the ring segments.

It is particularly preferred that the ring is attached to the rotor via the connecting disc already mentioned above, which is attached to the rotor shaft. The connecting disc can be formed from a sheet, which in particular consists of a metal. The connecting disc can be annular and engage in an annular groove that surrounds the rotor shaft in the circumferential direction. The connecting disc can be attached to the rotor shaft by means of caulking. As seen radially, the connecting disc can be screwed to the inside of an end face of the rotor shaft extending in the radial direction, wherein both the rotor and the ring are attached to the rotor shaft by means of this connection.

The connecting disc can have holes running axially through it. Screws can be passed through the holes using which the rotor is attached to the connecting disc. The screws can be screwed into threaded holes in the ring, wherein the heads of the screws are supported on the rotor, in particular in corresponding countersunk holes. The screws are therefore used to connect the rotor and the ring to the connecting disc, which in turn is attached to the rotor shaft.

Typically, the rotor is not designed to be axially symmetrical around its connection point on the rotor shaft. At high speeds, a centrifugal force of the rotor acting radially outwards consequently results, which is effective in a manner axially offset with respect to the connection point of the rotor. This generates a torque acting on the rotor, which deforms or bends the rotor in the axial direction, resulting in a change in the width of an air gap between the rotor and the stator of the electric machine. The distance between the rotor-side and stator-side magnets also changes accordingly, which is unfavorable for the operation of the electric machine. In order to counter this effect, in the rotor assembly, the rotor and the connecting disc and possibly other components of the rotor assembly can be designed and adapted to one another with regard to their geometric dimensions, masses and material properties in such a way that the change in the width of the air gap between the rotor and the stator that occurs during the rotation of the rotor assembly about the axis of rotation or rotor shaft axis is at least partially compensated for. The use of the connecting disc to connect the rotor to the rotor shaft thus creates a further degree of freedom with regard to the constructive design, namely with regard to the mechanical and geometric properties of the connecting disc. This can also deform during rotation due to the centrifugal force of the rotor, wherein this deformation counteracts or compensates for the deformation described above, which causes the change in gap width. For example, the dimensions and the modulus of elasticity of the connecting disc can be selected such that the deformation of the connecting disc caused in the rotation at least partially and preferably completely compensates for the deformation of the rotor with regard to the change in gap width.

In the module according to the disclosure, at least one element impeding the displacement of the damping fluid, in particular an orifice and/or a throttle, can be arranged in the region of the volume. The impeding element causes a constriction in the volume in such a way that when the damping fluid is displaced, an additional resistance is generated in addition to the resistance already present due to the viscosity of the damping fluid, which increases the damping effect. As such, the gap can be connected to a further gap and/or the damping fluid reservoir via the impeding element. Additionally or alternatively, the impeding element can be provided in the region of the volume compensation section. The impeding element provided as an orifice can be a disc with multiple through-holes. The impeding element provided as a throttle can be a perforated disc, for example with a central hole.

The vibration damping realized in the present disclosure can also be effected predominantly or completely by means of the impeding element. In this case, the planar gap can have such a large gap size that there is hardly any resistance from the damping fluid in the region of the gap, but that the required resistance is provided by means of the impeding element instead. In this embodiment, the gap ultimately, predominantly or exclusively, causes the fluid displacement via the impeding element.

The present disclosure further relates to an electric machine comprising at least one module according to any one of the preceding claims. The electric machine is particularly preferably an axial flux machine, in particular according to an H or I arrangement already explained above. Preferably, the electric machine has both a module designed as a rotor assembly and a module designed as a stator assembly in accordance with the disclosure. All the advantages, aspects and features explained in connection with the module according to the disclosure apply equally to the electric machine according to the disclosure and vice versa.

### BRIEF DESCRIPTION OF THE DRAWINGS

Further advantages and details of the present disclosure result from the exemplary embodiments explained below and from the drawings. In the schematic drawings:

FIG. 1 shows a longitudinal section of a first exemplary embodiment of an electric machine according to the disclosure, comprising a first exemplary embodiment of a module according to the disclosure, which is designed as a rotor assembly,

FIG. 2 shows a detailed view of the module of FIG. 1 in a longitudinal section,

FIG. 3 shows an exploded view of the module of FIGS. 1 and 2,

FIG. 4 shows a schematic longitudinal sectional view of the module of FIGS. 1 to 3 in order to illustrate the fundamental mode of oscillation of the rotors of the rotor assembly,

FIGS. 5-7 show possible features and/or modifications of the module of the preceding figures, and

FIGS. 8-9 show a schematic diagram in order to explain the torque ratios for the module of the preceding figures, and

FIG. 10 shows a longitudinal section of a second exemplary embodiment of an electric machine according to the disclosure, comprising a second exemplary embodiment of a module according to the disclosure designed as a rotor assembly and a third exemplary embodiment of a module according to the disclosure designed as a stator assembly.

### DETAILED DESCRIPTION

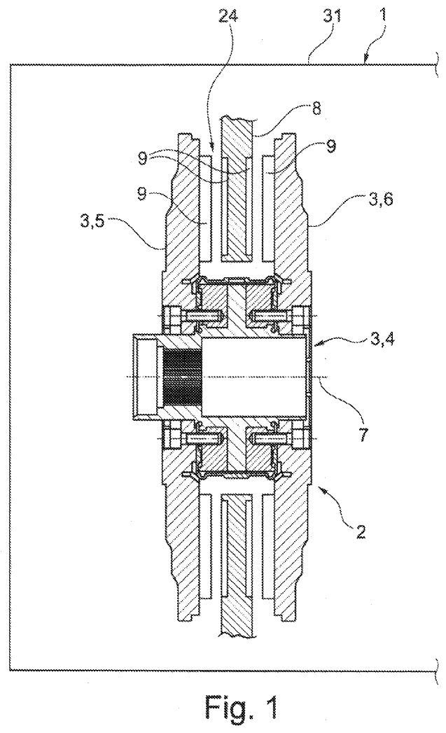

FIG. 1 schematically shows a longitudinal section through an exemplary embodiment of an electric machine 1 according to the disclosure, comprising a first exemplary embodiment of a module according to the disclosure, in the present case a rotor assembly 2. The rotor assembly 2 arranged in a housing 31 of the electric machine 1, which is not shown in detail in the figures, is rotatably mounted about an axis of rotation 7 extending along the axial direction. It comprises multiple components 3, namely a rotor shaft 4 and two disc-shaped rotors 5, 6 attached to the rotor shaft 4.

The electric machine 1 is designed as an axial flux machine, wherein a stator 8 of the electric machine 1 extends between the rotors 5, 6. The stator 8 of the electric machine 1 is attached to the housing 31 in a non-rotatable manner. The electric machine 1 is designed as a so-called H arrangement, as the rotors 5, 6 together with the rotor shaft 4 are reminiscent of the shape of the letter H. Alternatively, the electric machine 1 can be designed as an I arrangement, in which two stators are provided, between which a rotor is arranged. Magnets 9 are arranged on the rotor 5, 6 and the stator 8 in each case, namely electromagnets and, if applicable, permanent magnets.

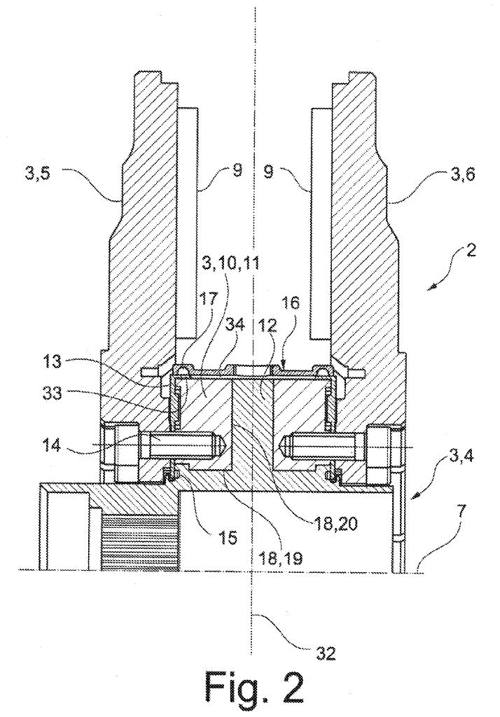

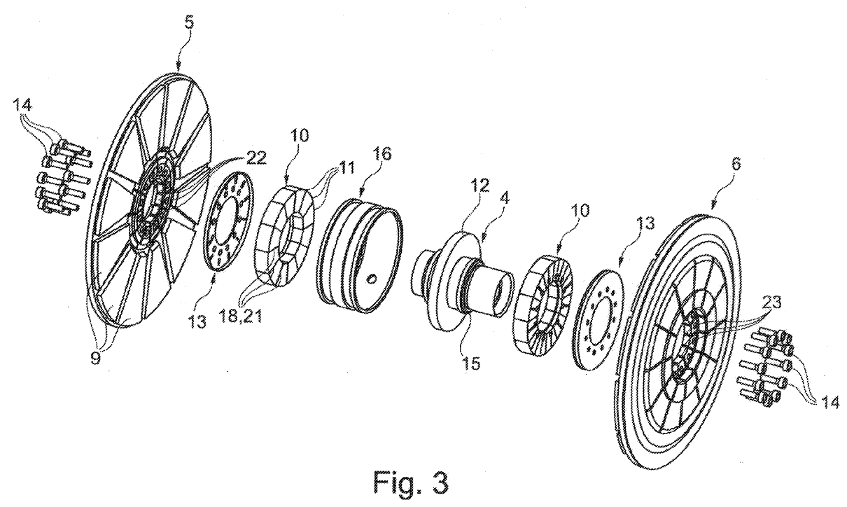

Further details pertaining to the rotor assembly 2 are explained below with reference to FIGS. 2 and 3. FIG. 2 shows the upper part of the cross-sectional view of FIG. 1, for the sake of clarity without the housing 31 and without the stator 8. Since the rotor assembly 2 is designed to be rotationally symmetrical about the axis of rotation 7, the lower part of the rotor assembly 2 not visible in FIG. 2 essentially corresponds to the upper part. FIG. 3 shows an exploded view of the rotor assembly 2. The rotors 5, 6 are designed to be mirror-symmetrical with respect to an axis or plane 32 perpendicular to the axis of rotation 7, so that the aspects explained below merely with reference to the rotor 5 apply equally to the rotor 6.

A further component 3 of the rotor assembly 2 is a ring 10 arranged next to the rotor 5 as seen in the axial direction, which surrounds the rotor shaft 4 in the circumferential direction and to which the rotor 5 is attached. The ring 10 is arranged between the rotor 5 and a shaft shoulder 12 formed as a flange-like widening of the rotor shaft 4. A connecting disc 13 is arranged between the ring 10 and the rotor 5, via which the ring 10 is attached to the rotor 5 and which is a sheet metal disc here, merely by way of example. The connecting disc 13 is caulked to the rotor shaft in the region of a shaft section 15 of the rotor shaft 4, wherein the rotor 5 and the ring 10 are attached to the rotor shaft 4 by means of this connection. Additionally or alternatively, it is conceivable that the connecting disc 13 is attached to the rotor shaft 4 by means of further attachment methods, for example by means of a screw connection and/or welding or the like. Ultimately, attaching the connecting disc 13 to the rotor shaft 4 is sufficient in order to ensure that the required torque can be transmitted from the rotor 5 to the rotor shaft 4 and that sufficient support is provided with regard to an axial magnetic force.

The ring 10 comprises multiple identical ring segments 11, twelve in this example. Screws 14 are provided for attaching the ring 10 to the rotor 5, which pass through the rotor 5 and the connecting disc 13 and are each screwed into a threaded hole in the ring 10. Each of the ring segments 11 has a corresponding threaded hole for this purpose, so that each of the ring segments 12 is attached via a separate screw 14. A total of twelve screws 14 are therefore provided.

Furthermore, a sealing element 16 designed as a sealing sleeve is provided which, as seen in the radial direction, completely surrounds the ring 10 and the shaft shoulder 12 on the outside. The sealing element 16 is tubular or sleeve-like and diaphragm-like and is made, for example, of an elastic plastic, wherein a metal is also conceivable as a material. The sealing element 16 rests on a collar 33 of the connecting disc 13 extending in the axial direction and located radially on the outside. In order to form a fluid-tight seal, a sealing ring 17 made of an elastomer designed as an O-ring is arranged between the collar 33 and the axial end of the sealing element 16. Details regarding the specific purpose of the sealing element 16 will be explained later.

Between the components 3, in this case between the ring 10 and the rotor shaft 4 and between the ring 10 and the shaft shoulder 12, planar gaps 18 filled with a damping fluid are formed. The gaps 18 are thus an axial gap 19 extending in the axial direction and along the circumferential direction and a radial gap 20 extending in the radial direction. Further gaps 18, namely segment gaps 21, are formed between the ring segments 11, which extend along the radial and axial directions. The gaps 18, in particular the radial gap 20, have a gap size or gap width of between 0.1 mm and 0.3 mm.

All the gaps 18 noted in connection with the rotor 5 are likewise present in the rotor 6.

The gaps 18 together form a volume which comprises the intermediate spaces between the ring 10 and the rotor shaft 4, between the ring 10 and the shaft shoulder 12 and between two adjacent ring segments 11. The volume or gap 18 is filled with the damping fluid provided as an oil. An oscillation or vibration of one of the components 3 causes the geometry or gap width of at least one of the gaps 18 to change, which leads to a displacement of the damping fluid within the volume. In particular due to the viscosity, this displacement causes a damping of the vibration, which can also be referred to as squeeze oil damping. This vibration can be an oscillation present on the part of the rotors 5, 6, which frequently occurs during dynamic operation of the electric machine 1. The connecting disc 13 has a flexibility or softness such that the vibration of the rotors 5, 6 is transmitted to the respective ring 10 and consequently to the gap 18.

As already explained above, the sealing element 16 rests on the end, as seen axially, of a collar 33 of the two connecting discs 13 in each case, forming a fluid-tight seal by means of the sealing ring 17. The collar 33 ultimately forms a spacer such that a gap-like intermediate space 34 is formed between the sealing element 16 and the ring 10 as well as the shaft shoulder 12, which connects the gap 18 associated with the left rotor 5 with the gap associated with the right rotor 6. Consequently, the damping fluid can be displaced from the gaps 18 associated with the left rotor 5 in FIG. 2 to the gaps 18 associated with the right rotor 6 in FIG. 2 and vice versa.

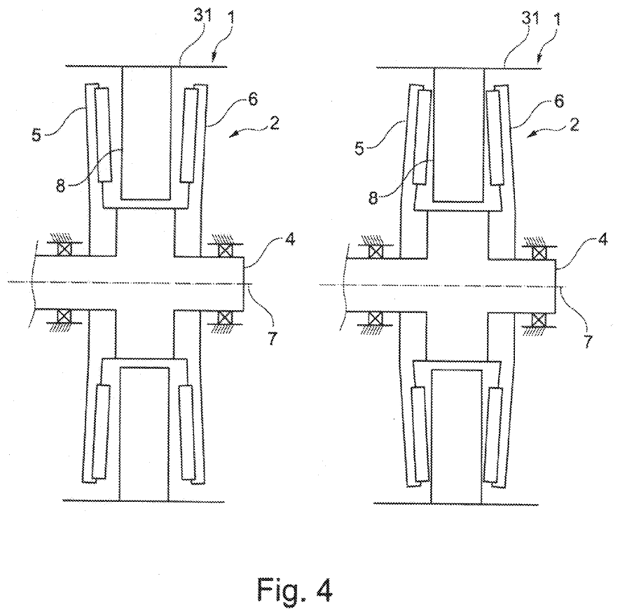

The oscillations occurring on the part of the disc-like rotors 5, 6 mainly occur on the radial edge or in the radially outer region of the respective rotor 5, 6. In other words, the oscillations are most pronounced in the outer edge region, as seen radially, of the rotors 5, 6 and therefore have the greatest amplitude or deflection there. For better understanding in this regard, a schematic view of the electric machine 1 is shown on the left and right in FIG. 4, wherein the two sides of this figure each show the electric machine 1 when the deflection of the rotors 5, 6 caused by the oscillation assumes the maximum deflection in each case. The geometric shape of the rotors 5, 6 in this fundamental mode of oscillation is reminiscent of an umbrella, so that this mode is also referred to as the umbrella mode.

In order to effectively transmit the oscillatory movements illustrated in FIG. 4 via the connecting disc 13 to the ring 10 and consequently to the gaps 18 and thus to achieve the best possible damping effect, it is necessary to transmit the oscillatory movement to the inner region, as seen radially, of the respective rotor 5, 6. Referring again to FIGS. 1 to 3, this is achieved by means of spring tongues 22 of the rotor 5, 6, which extend from the radially outer region into the radially inner region of the rotor 5, 6. The spring tongues 22 are separated from one another by gaps 23 that run along the radial direction. With reference to FIG. 2, a deflection of the left-hand rotor 5 to the left caused by the oscillations causes a correspondingly opposite deflection of the spring tongues 22 to the right and vice versa. The number of spring tongues 22 corresponds to the number of ring segments 11, wherein each of the ring segments 11 is connected to one of the spring tongues 22 via one of the screws 14.

In the exemplary embodiment shown, the division of the rotor 5 into sectors with regard to the spring tongues 22 corresponds to the division of the rotor 5 into sectors with regard to the magnets 9. In the region of the magnets 9, the gaps 23 do not completely cut through the rotor 5 in the axial direction, but only through a part on the side of the rotor 5 facing away from the magnets 9. Otherwise, the magnetic flux conduction in the rotor 5 required for the correct functioning of the electric machine 1 would not be provided or would be impaired. Specifically, the magnets 9 on the rotor 5 are supported by a ring- or disc-shaped carrier component made of a flux conducting material, which is not shown in detail in the figures. The carrier component is closed, i.e., the slots 23 visible on the right-hand rotor 6 in FIG. 3 only extend in the axial direction as far as the carrier component. The spring tongues 22 are ultimately formed in the non-electromagnetically effective part of the rotor 5, namely in the vicinity of the screws 14.

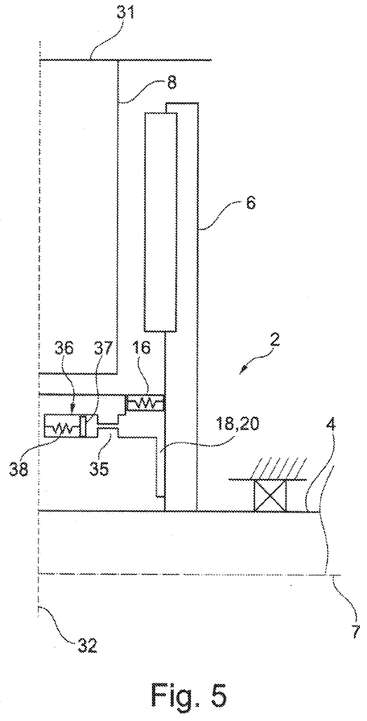

Further aspects of the electric machine 1 and the rotor assembly 2 according to the disclosure are explained below with reference to FIGS. 5 to 7. In these figures, details such as those relating to the ring 10, the connecting disc 13 and the shaft shoulder 12 are omitted for reasons of clarity. The sealing element 16 is only indicated schematically in these figures.

FIG. 5 shows aspects of the rotor assembly 2 with regard to an element 35 that impedes the displacement of the damping fluid, by means of which the damping effect described above is increased. The impeding element 35 can be an orifice or a throttle, for example, which further increases the viscosity-related flow resistance of the damping fluid or causes an additional component of the flow resistance in this respect. It is also conceivable with regard to the impeding element 35 that this element predominantly or completely causes the damping effect with regard to the vibrations or oscillations.

In FIG. 5, the axial gap 20 is specifically formed, in the region of which a volume compensation section 36 is provided, in the region of which, in turn, the impeding element 35 is arranged. The volume compensation section 36 ensures that the total capacity of the volume remains the same despite the change in the width of the axial gap 20. The volume compensation section 36 is formed as a depression, specifically as a blind bore, in the ring 10 and/or the shaft shoulder 12. With reference to the positioning of the volume compensation section 36 shown in FIG. 5, the section can also be provided further down and branching off at an angle from the gap 18. A pressure piston 37, which seals the blind bore in a fluid-tight manner and is movable towards the base, is arranged at the base of the volume compensation section 36 or the depression and is coupled to the base of the blind bore via a compression spring 38. A change in the capacity of the volume is compensated for by the movement of the pressure piston 37, which takes place against the elastic restoring force of the compression spring 38.

With regard to the specific embodiment of the volume compensation section 36, additional or alternative options are conceivable which deviate from the embodiments specifically shown in the figures. For example, a gas cushion or another compressible element can be provided instead of the compression spring 38. In principle, the pressure piston 37 is also dispensable, since a balance gas forming a nitrogen cushion, for example, can be provided as an alternative, wherein the damping fluid and the balance gas are only separated from one another via the corresponding phase boundary. The volume compensation can also be realized using the emulsion damping principle.

In addition or as an alternative to the volume compensation section 36, it is also possible with respect to the volume compensation for the sealing element 16 to exhibit elasticity with respect to the radial direction, so that the oil can accumulate in the gap-like intermediate space 34 under a radial bulge of the sealing element 16.

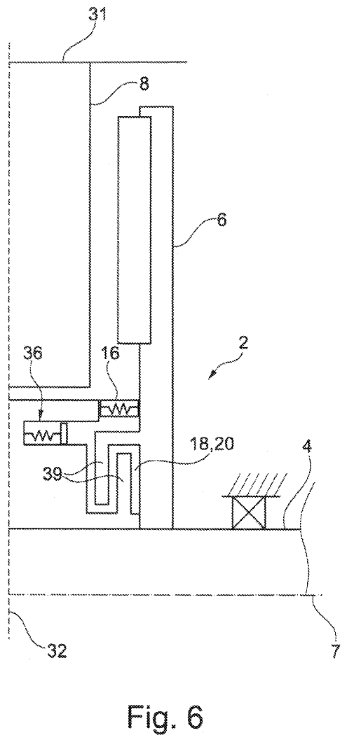

The rotor assembly 2 shown in FIG. 6 largely corresponds to the one shown in FIG. 5. The difference, however, is that the gap 18 is designed in a meandering or labyrinthine manner and is therefore lengthened. This geometric shape is realized by means of interlocking projections 39 of the components 3, the walls of which delimit the gap 18. Consequently, more oil is displaced when the gap width is changed, so that the damping effect is increased accordingly.

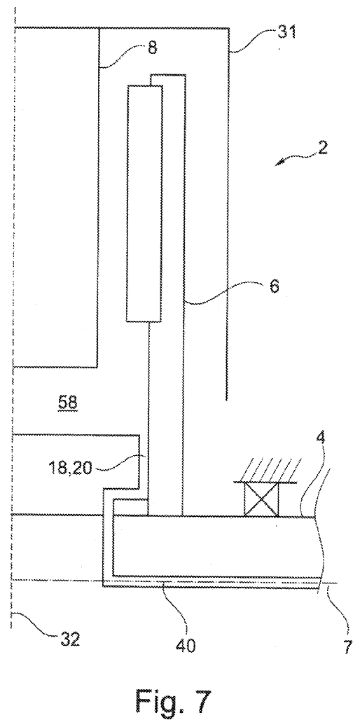

A further possible variation of the module or rotor assembly 2 according to the disclosure is explained with reference to FIG. 7. In this embodiment, the volume formed by the gap 18 is open. For this purpose, the rotor shaft 4 has a damping fluid supply channel 40, through which the oil is supplied to the gap 18 from a damping fluid reservoir not shown in detail. The damping fluid supply channel 40 runs along the axial direction through the rotor shaft 4. On the radially outer side, the volume or gap 18 is also open, so that the oil can then escape into an interior space 58 of the electric machine 1 delimited by the housing 31. In this embodiment, the damping fluid therefore also serves as a lubricant and/or coolant.

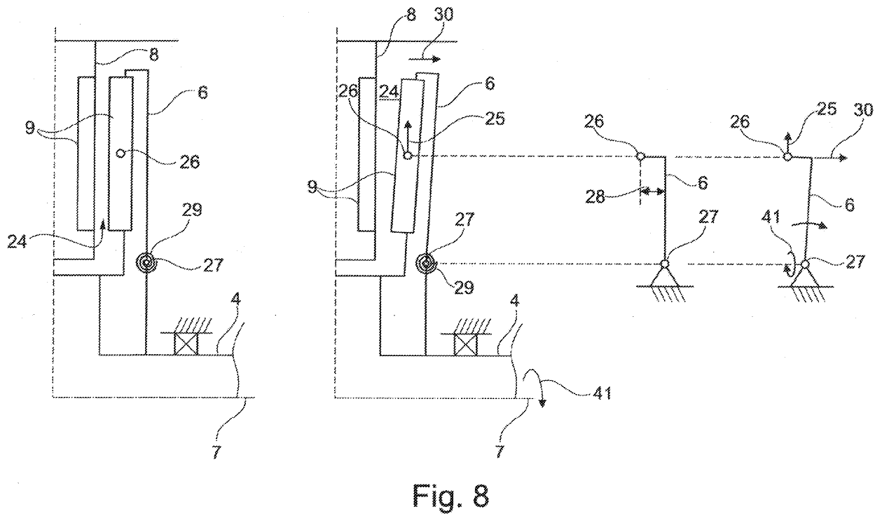

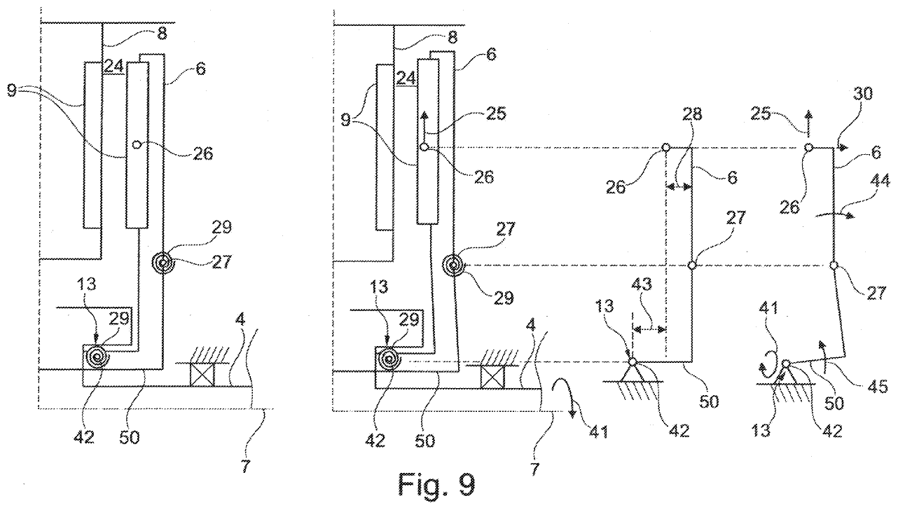

In the following, FIGS. 8 and 9 are used to explain an advantage with respect to the module or rotor assembly 2 according to the disclosure that is achieved by using the connecting disc 13. FIG. 8 shows an embodiment of the module or rotor assembly 2 according to the disclosure in which the connecting disc 13 is not provided. The left-hand partial illustration of FIG. 8 shows the case in which the rotor assembly 2 does not rotate. The second partial illustration from the left shows the case in which the rotor assembly 2 rotates, wherein the rotation is indicated by the arrow 41. The two partial illustrations on the right in FIG. 8 show the same as the two partial illustrations on the left in FIG. 8 in a highly simplified or schematic form. FIG. 9 shows the same as FIG. 8, with the difference that in the rotor assembly shown in FIG. 9, the connecting disc 13 is provided, which is only indicated in a highly schematic manner, however. The aspects explained with respect to FIGS. 8 and 9 are illustrated with reference to the rotor 6, but apply equally to the rotor 5.

With reference to FIG. 8, the rotor 6 is not designed to be axially symmetrical around its connection point 27 on the rotor shaft 4. This is due, in particular, to the fact that the magnets 9 are only provided on one side of the rotor 6. Consequently, the center of gravity 26 of the rotor 6 is axially offset with respect to the connection point 27, so that a centrifugal force 25, which is naturally stronger the higher the speed of the rotor assembly 2, does not act on the connection point 27, but in a manner axially offset therefrom. This creates a lever arm 28 between the connection point 27 and the center of gravity 26, on which the centrifugal force 25 acts. Since the rotor 6 is, in reality, not a rigid component, but exhibits elasticity or stiffness, which is symbolically indicated in the figures by the spiral 29, the rotor 5 bends in the event of rotation, so that the center of gravity 16 shifts clockwise as indicated by the arrow 30 and thus the width of an air gap 24, which is present between the rotor 6 and the stator 8, changes. This change obviously also results in a change in the distance between the magnets 9 of the rotor 6 and stator 8, which is disadvantageous with regard to the operation of the electric machine 1.

This problem can be mitigated or ideally avoided by using the connecting disc 13. With reference to FIG. 9, the rotor 6, akin to the rotor 6 shown in FIG. 8, is connected to the rotor shaft 4 at the connection point 27. In the configuration shown in FIG. 9, however, this connection is made via an axial extension 50 of the rotor 6, which is, in turn, connected to the rotor shaft 4 via the connecting disc 13. Here, the connecting disc 13 is located at the connection point 42 at which it is attached to the rotor shaft 4.

In the same way as in the configuration shown in FIG. 8, the center of gravity 26 of the rotor 6 is positioned offset in the axial direction with respect to the connection point 27, namely offset by the lever arm 28. The same also applies to the connection point 42, wherein the lever arm 43 is present between this point and the center of gravity 26. When the rotor 6 rotates, there is, on the one hand, a change in the width of the air gap 24 due to the lever effect with respect to the lever arm 28, which is indicated by the arrow 44. On the other hand, there is a change in the width of the air gap 24 due to the lever effect with respect to the lever arm 43, which is, in turn, indicated by the arrow 45. As can be seen, the two changes in width occur in opposite directions. In the exemplary embodiment shown, this effect is utilized in such a way that the properties of the rotor 6 and the connecting disc 13, i.e., their geometric dimensions, masses and moduli of elasticity, are adapted to one another in such a way that the displacement of the center of gravity 26 induced by the centrifugal force and thus the change in width of the air gap 24 is completely compensated for or at least significantly reduced. This is indicated in FIG. 9 by the shorter arrow 30 compared to FIG. 8.

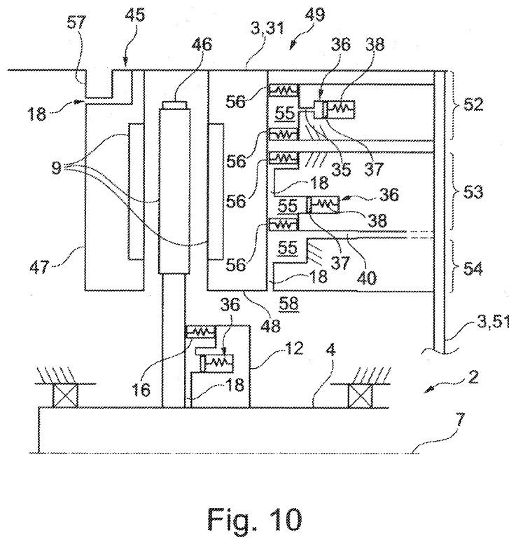

FIG. 10 illustrates a second embodiment of an electric machine 45 according to the disclosure. This electric machine is implemented in the manner of an I arrangement as already mentioned above, wherein in the rotor assembly 2 of the electric machine 45 only a single rotor 46 is attached to the rotor shaft 4. As seen in the axial direction, a stator 47, 48 each is arranged on both sides of the rotor 46. The stators 47, 48 are part of a module of the electric machine 45 provided as a stator assembly 49 according to the disclosure.

The rotor 46 is arranged next to the shaft shoulder 12, wherein the ring 10 and/or the connecting disc 13 can also be provided, which are not shown in FIG. 10 for reasons of clarity. The aspects set out above with regard to the rotor assembly 2 ultimately apply equally to the electric machine 45 and will not be repeated here.

Details pertaining to the stator assembly 49 are explained below. This assembly also has gaps 18 forming a volume, which extend between components 3 of the stator assembly 49. The gaps 18 are filled with the damping fluid and consequently cause a damping of a vibration of the components 3 of the stator assembly 49 as explained above. The stator 47 is connected or attached to the housing 31, wherein the gap 18 is arranged between the housing 31 or a flange 57 of the housing and the stator 47. In the region of the gap 18 extending in the axial direction, which is not shown in detail, the volume compensation section 36 is provided together with the impeding element 35, pressure piston 37 and compression spring 38. In this embodiment, the alternative options with regard to the volume compensation section 36 explained above are also conceivable.

The stator 48 is also connected or attached to the housing 31, wherein the volume or gap 18 extends axially between a housing cover 51 of the housing 31 and the stator 48. In the embodiment shown in FIG. 10, the housing 31 and the housing cover 51 are considered components 3 of the stator assembly 49. With regard to the stator 48, FIG. 10 shows three different configurations 52, 53, 54 with regard to the formation of the volume, which can be implemented individually or in any combination with one another.

As such, with respect to the first configuration 52, the volume is formed as a chamber 55 which is delimited by the stator 48 and the housing cover 51. The volume compensation section 36 is provided together with the impeding element 35, pressure piston 37 and compression spring 38 in the region of the chamber 55. The volume compensation section 36 is arranged on or formed on the housing cover 51. Furthermore, the chamber 55 is sealed by means of axially flexible or elastic seals 56, so that the geometry of the chamber 55 can be changed if a vibration or oscillation occurs in the stator 48. The seals 56 are sealing rings attached to the housing cover 51.

With respect to the second configuration 53, the gap 18 is provided in addition to the chamber 55. Furthermore, the volume compensation section 36 is provided together with the pressure piston 37 and the compression spring 38, but without the impeding element 35. The alternative options conceivable with regard to the volume compensation section 36 are also conceivable here. The volume comprising the gap 18 and the chamber 55 in the second configuration 53 is also sealed by means of the elastic seals 56.

With respect to the third configuration 54, the volume comprising the gap 18 and the chamber 55 is open. Accordingly, in this embodiment, the damping fluid supply channel 40 is provided, which can be formed on the housing cover 51, for example, and through which the oil is supplied to the volume from a damping fluid reservoir not shown in detail. In this embodiment, the volume is further open to the interior space 58 of the electric machine 45 delimited by the housing 31, so that the fluid also serves as a lubricant and/or coolant.

In the following, an optional possibility is described with regard to the open volume of the third configuration 54, which can equally be provided in the embodiment explained with reference to FIG. 7. This allows the damping fluid to circulate in the case of the open volume and be conveyed or recirculated accordingly by means of a fluid pump. Specifically, the damping fluid can be conveyed from the damping fluid reservoir to the gap 18 and the chamber 55 via the damping fluid supply channel 40. From here, the damping fluid can be conveyed further into the interior space 58, where it collects in a damping fluid collecting section of the electric machine 45, not shown in detail in the figures, due to the influence of gravity. It is conceivable that the damping fluid collecting section is the damping fluid reservoir or that the damping fluid is conveyed from the damping fluid collecting section to the damping fluid reservoir.

### LIST OF REFERENCE SIGNS

1 Electric machine
2 Rotor assembly
3 First component
4 Rotor shaft
5 Rotor
6 Rotor
7 Axis of rotation
8 Stator
9 Magnet
10 Ring
11 Ring segment
12 Shaft shoulder
13 Connecting disc
14 Screw
15 Shaft section
16 Sealing element
17 Sealing ring
18 Gap
19 Axial gap
20 Radial gap
21 Segment gap
22 Spring tongue
23 Gap
24 Air gap
25 Centrifugal force
26 Center of gravity
27 Connection point
28 Lever arm
29 Spiral
30 Arrow
31 Housing
32 Plane
33 Collar
34 Intermediate space
35 Impeding element
36 Volume compensation section
37 Pressure piston
38 Compression spring
39 Projection
40 Damping fluid supply channel
41 Arrow
42 Connection point
43 Lever arm
44 Arrow
45 Electric machine
46 Rotor
47 Stator
48 Stator
49 Stator assembly
50 Axial extension
51 Housing cover
52 Configuration
53 Configuration
54 Configuration
55 Chamber
56 Seal
57 Flange
58 Interior space

1. A module for an electric machine, having multiple components, the module comprising:
at least one volume filled with a damping fluid formed between at least two of the components, wherein, for vibration damping, the damping fluid is displaceable as a result of a change in a geometry of the at least one volume resulting from an elastic oscillation of at least one of the components delimiting the volume.

2. The module according to claim 1, wherein the volume is a gap or comprises a gap.

3. The module according to claim 2, wherein the module comprises a rotor assembly for the electric machine, a first one of the components is a rotor shaft of the rotor assembly and a second one of the components is a disc-shaped rotor of the rotor assembly of an axial flux machine, which is attached directly or indirectly to the rotor shaft, wherein the volume is formed at least one of between the rotor shaft and the rotor or between the rotor shaft and a third component of the rotor assembly attached to the rotor.

4. The module according to claim 3, wherein the third component is a ring which is arranged next to the rotor as seen in an axial direction, surrounds the rotor shaft in a circumferential direction and is attached to the rotor, wherein the gap is at least one of an axial gap which extends in the axial direction and along the circumferential direction and is arranged between the ring and the rotor shaft or a radial gap which extends at an angle to the axial direction, and is arranged between the ring and a shaft shoulder which widens the rotor shaft in a radial direction and is arranged next to the ring as seen in the axial direction.

5. The module according to claim 4, wherein the ring, as seen in the radial direction, is surrounded on an outside by a sealing element by which at least one of the gaps is sealed in a fluid-tight manner.

6. The module according to claim 4, wherein the ring is composed of multiple separate ring segments each connected to the rotor, wherein the gap is, formed between at least two of the ring segments.

7. The module according to claim 4, wherein the rotor has spring tongues extending at least partially in the radial direction in an inner region as seen in the radial direction and connected to the ring such that rotor movements caused by a natural oscillation of the rotor are transmittable to the ring via the spring tongues.

8. The module according to claim 4, wherein the ring is attached to the rotor via a connecting disc attached to the rotor shaft.

9. The module according to claim 1, wherein at least one element impeding displacement of the damping fluid is arranged in a region of the volume.

10. An electric machine, comprising at least one module according to claim 1.

11. An electric machine, comprising:
a stator assembly;
a rotor assembly;
a module having at least one volume filled with a damping fluid formed between at least two components of at least one of the stator assembly or the rotor assembly, the damping fluid being displaceable as a result of a change in a geometry of the at least one volume resulting from an elastic oscillation of at least one of the components delimiting the volume to damp vibration.

12. The module according to claim 11, wherein the volume is a gap or comprises a gap.

13. The module according to claim 12, wherein the module is formed in the rotor assembly, a first one of the components is a rotor shaft of the rotor assembly and a second one of the components is a disc-shaped rotor of the rotor assembly, which is attached directly or indirectly to the rotor shaft, wherein the volume is formed at least one of between the rotor shaft and the rotor or between the rotor shaft and a third component of the rotor assembly attached to the rotor.

14. The module according to claim 13, wherein the third component is a ring which is arranged next to the rotor as seen in an axial direction, surrounds the rotor shaft in a circumferential direction and is attached to the rotor, wherein the gap is at least one of an axial gap which extends in the axial direction and along the circumferential direction and is arranged between the ring and the rotor shaft or a radial gap which extends at an angle to the axial direction, and is arranged between the ring and a shaft shoulder which widens the rotor shaft in a radial direction and is arranged next to the ring as seen in the axial direction.

15. The module according to claim 14, wherein the ring, as seen in the radial direction, is surrounded on an outside by a sealing element by which at least one of the gaps is sealed in a fluid-tight manner.

16. The module according to claim 14, wherein the ring is composed of multiple separate ring segments each connected to the rotor, wherein the gap is, formed between at least two of the ring segments.

17. The module according to claim 14, wherein the rotor has spring tongues extending at least partially in the radial direction in an inner region as seen in the radial direction and connected to the ring such that rotor movements caused by a natural oscillation of the rotor are transmittable to the ring via the spring tongues.

18. The module according to claim 14, wherein the ring is attached to the rotor via a connecting disc attached to the rotor shaft.

19. The module according to claim 11, wherein at least one element impeding displacement of the damping fluid is arranged in a region of the volume.

20. The module according to claim 19, wherein the at least one element comprises at least one of an orifice or a throttle.
